(19) United States
(12) Patent Application Publication
(10) Pub. No.: US 2010/0197547 A1
(43) Pub. Date: Aug. 5, 2010

(54) Emanator Blister

(75) Inventors: Karl Ludwig Gibis, Limburgerhof (DE); Chris Efstathios Housmekerides, Ludwigshafen (DE); Rainer Link, Ludwigshafen (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: RECKITT BENCKISER N.V., Hoofddorp (NL)

(21) Appl. No.: 11/910,785

(22) PCT Filed: Apr. 12, 2006
(86) PCT No.: PCT/GB06/01328

§ 371 Date: Nov. 6, 2007

(30) Foreign Application Priority Data
Apr. 13, 2005 (US) 0507404.2

(51) Int. Cl. C11D 17/00

(52) U.S. Cl. 510/224

(57) ABSTRACT

An emanator blister, has a membrane comprising PET/PBT. The blister contains a liquid detersive active.

The present invention relates to an emanator blister for emanating an active component. The blister finds particular use in a machine dishwasher, for the emanation of detergent components.

The usual means for dosing detergents and other components required in the dishwashing process include the integrated dispenser of the machine. Powder, tablets and liquid detergents are dosed via this means. The integrated dispenser means usually has to be charged every time the machine is run, which is inconvenient for the consumer.

Some dishwasher active components, such as rinse aid, may be dosed using a multi-dose dispenser which can typically release rinse aid for more than 10 wash cycles. These kind of dispensers are also inconvenient as commonly the warning mechanism, which alerts the need to recharge the dispenser, goes un-noticed by the consumer. Furthermore the dosage means need to be refilled which is inconvenient and often messy

Emanators in dishwashers are well known. Where the component is a liquid (such as a fragrance) the emanator may comprise a blister; namely a body containing the liquid to be emanated. Emanation may occur from the blister following piercing or by passage through a permeable blister component.

In permeable blisters, usually the permeable blister component comprises a film/membrane which may be transparent to allow the user to observe the blister contents and determine when the blister needs to be changed. The blister contents may be coloured to facilitate this process.

Generally the film/membrane comprises a water insoluble component to avoid being detrimentally affected in use in the dishwasher. Examples of the material used in these films include polymers of unsaturated hydrocarbons (such as ethylene and propylene) which may also be functionalised (for example with halogen such as chlorine). The film/membrane can also be multi-layer and comprise a water-soluble layer which is removed in use and which provides a protective barrier before use.

For example, DE-A-4205975 describes a manufacturing method for a membrane and a membrane composition. The membrane consists of a blend of polyethylene (PE) and 4 to 10 wt % polyethylacrylate (PEEA). The membrane thickness varies between 80 and 140 μm and is coated with a water soluble layer of polyvinyl alcohol (PVA). Both layers are glued together by applying a hydrophobic hot-melt adhesive such as PE. These membrane emanators are used in fragrance release devices, e.g. for use in a dishwasher.

GB-A-2 066 665 describes other membrane materials, such as copolymers of ethylene with vinyl acetate.

WO 97/01625 describes a detergent for use in an automatic dishwasher which detergent is in the form of a detergent containing package comprising a water-permeable membrane.

U.S. Pat. No. 4,356,099 discloses a fabric treatment product for use in washing machines consisting of a bag formed of water-insoluble, water-impermeable synthetic plastics sheet material having a weak seal that is opened by the mechanical action of the washing machine.

JP 2005104140 discloses a film having a biaxially oriented polyamide film and heat sealing layer laminated by a biaxially oriented polyester film. The film is used for packaging applications such as those for liquid detergents.

A disadvantage of blisters having such films/membranes is that, with blisters intended for multi-cycle dosing, the blisters typically exhibit a non-linear release of the contained component. This has the effect that in the first few washes a relatively large amount of material is released and in later washes a smaller amount of material is released. Obviously this effect is undesirable and has been recognised in GB-A-2 400 608 which describes an emanator blister comprising a non-water soluble membrane which may be stabilised with a UV stabiliser or an anti-oxidant and/or comprises filling or reinforcement materials.

This effect is particularly noticeable when the emanator blister is used to release a fragrance: in the first few washes the amount of fragrance released (such as at the end of the wash cycle to overcome any unpleasant odour associated with washing) is overpowering. Conversely, the amount of fragrance released after several wash cycles can reach, in extreme cases, a negligible/non-perceptible level.

It is an object of the present invention to obviate/mitigate the problems outlined above.

According to the invention there is provided an emanator blister, having a membrane comprising PET/PBT, the blister containing a liquid detersive active.

Generally the emanator blister is for use in an automatic dishwasher. Alternatively the emanator may be for use in a washing machine.

We have found that emanator blisters in accordance with the present invention display particularly effective linear release of the blister contents. This has been especially noticeable when used in a multi-dose emanator device for the supply of detersive active to, for example, a dishwasher. In this use it has been observed that the amount of emanator content released per dishwasher cycle is relatively constant. Namely, the release rate appears to be independent of the content of the blister. This is in contrast to previous emanator devices which display a release rate typified by an exponential release curve.

Most preferably the PET/PBT is a thermoplastic elastomeric blend having a lowered melt processing temperature comprising:—

(A) from 5 to 97.5 weight percent and preferably from 5 to 80 weight percent of a segmented thermoplastic copolyester composition consisting essentially of a multiplicity of recurring long-chain ester units and short-chain ester units joined head-to-tail through ester linkages, said long-chain ester units being represented by the formula

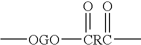

and said short-chain units being represented by the formula

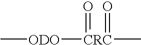

where G is a divalent radical remaining after the removal of terminal hydroxyl groups from a poly-(alkylene oxide) glycol having a molecular weight of about 400-6,000 and a carbon to oxygen ratio of about 2.0-4.3; R is a divalent radical remaining after removal of carboxyl groups from a dicarboxylic acid having a molecular weight less than about 300 and D is a divalent radical remaining after removal of hydroxyl groups from a diol having a molecular weight less than about 250; provided said short-chain ester units amount to about 15 to 95 percent by weight of said copolyester, and at least about 50 percent of said short-chain ester units are identical and
(B) from 2.5 to 95 weight percent and preferably from 20 to 95 weight percent of a partially crosslinked, thermoplastic, melt-processible, elastomeric blend of
(a) a copolymer of ethylene and one or more ethyl-enically unsaturated organic comonomers selected from the class consisting of esters of ethylenically unsaturated C₃-C₂₀ Mono- or dicarboxylic acids, vinyl esters of saturated C₂-C₁₈ carboxylic acids, vinyl alkyl ethers wherein the alkyl group has 1-18 carbon atoms, vinyl or vinylidene halides, acrylonitrile, methacrylonitrile, norbornene, alpha-olefins of 3-12 carbon atoms, and vinyl aromatic compounds and optionally an additional monomer selected from the class consisting of ethylenically unsaturated C₃-C₂₀ carboxylic acids, carbon monoxide and sulfur dioxide; and
(b) between 5 and 75 weight percent, based on the composition, of a vinyl or vinylidene halide polymer wherein the comonomer content in (a) is such that the ethylene copolymer is compatible with the vinyl or vinylidene halide polymer.

The ethylene copolymers useful as “B” (a) above can be represented as having the formula E/X/Y, where X is an ethylenically unsaturated organic monomer other than an unsaturated carboxylic acid, and Y is optional and is an ethylenically unsaturated carboxylic acid, carbon monoxide, or sulfur dioxide. Exemplary of the organic monomers are those selected from the group consisting of esters of said unsaturated mono- or dicarboxylic acids, vinyl esters of saturated carboxylic acids where the acid group has 2-18 carbon atoms, vinyl alkyl ethers wherein the alkyl group has 1-18 carbon atoms, vinyl or vinylidene halides, acrylonitrile, methacrylonitrile, norbornene, alpha-olefins of 3-12 carbon atoms, and vinyl aromatic compounds. Preferred organic monomers include methyl acrylate, butyl acrylate and vinyl acetate. The melt index range for these copolymers is 0.1 to 1000 (ASTM D-1238), preferably 1 to 100.

The melting point of the active PET/PBT membrane is preferably from 150 to 200° C., most preferably 170 to 180° C.

The membrane preferably comprises a protective layer to keep the liquid detersive active from migrating through the membrane when the product is in storage or transport. Preferably the protective layer dissolves/disperses during the first use of the blister, exposing the active membrane to release the inner surfactant contents. Therefore it is preferred that the barrier layer is soluble/dispersible in water. A preferred example is PVOH.

The current invention allows the lamination of a PET/PBT membrane foil with a PVOH film to form a stable emanator blister. The PET/PBT and PVOH laminate has been found to resist de-lamination even when stored for over 6 months. Furthermore no leakage was observed over this period.

The laminate preferably comprises a glue. A preferred glue is a solvent based two-component polyurethane glue (e.g. Novacote NC-2525/3 in combination with co-reactant CA-2526/3). Preferably the glue solvent is removed before lamination occurs to avoid solvent induced swelling of the membrane. Solvent removal is preferably performed by briefly (e.g., 4-5 seconds) exposing to an elevated temperature (e.g., 80-90° C.). The lamination of both webs is preferably done at ambient temperature to reduce curling and shrinking effects. To improve bond strength both layers, the membrane and the PVOH film, are preferably corona-treated immediately before the lamination process.

The detersive active is preferably a liquid formulation. Most preferably the liquid formulation includes water. Indeed it has been found that with the inclusion of water, membrane wrinkling issues, which can be caused on blister formation/exposure to blister contents, are greatly minimised.

Without wishing to be bound by theory it is proposed that this effect arises as the water content in the detersive active makes the PVOH layer flexible so that it can move with the membrane to avoiding de-lamination. This effect can also be achieved by the addition of a PVOH plasticiser, such as glycerine, to the detersive active.

By incorporating of the PVOH plasticiser in the detergent active (rather than directly in the PVOH) it has been found that de-lamination issues caused by, for example, PVOH shrinkage, are obviated.

Generally the amount of water in the detersive active is between 2-10 wt %, more preferably 4-8 wt % and most preferably about 5 wt %.

The emanator is most preferably used in the dispense of a surfactant to perform a cleaning operation in the dishwasher. Thus the liquid detersive active preferably contains a surfactant.

In this regard the use of the emanator of the present invention has been shown to have excellent release properties. As described above the emanator has been found to show a linear discharge of its contents with a uniform amount of content being released per washing cycle in a multi-cycle emanator. Additionally the emanator has been found to display such release properties with surfactants. Thus the emanator allows the preparation of a device which can dispense dishwasher surfactant (with linear release) into a machine dishwasher over a multi-cycle period. This has obvious consumer benefits including the removal of the need for dosing of surfactant with every dishwasher use and also due to the continuous release of surfactant during the whole washing process (including the pre-wash cycle, the main wash cycle, and the rinse cycle) the overall cleaning performance is enhanced.

Most preferably the surfactant is non-ionic. The surfactant is preferably low-foaming.

The non-ionic surfactant may be a amide surfactant. Polyhydroxy fatty acid amides suitable for use herein are those having the structural formula R₁CONR₂Z wherein:

R₁ is H, C₁-C₄ hydrocarbyl, 2-hydroxy ethyl, 2-hydroxy propyl, or a mixture thereof, preferable C₁-C₄ alkyl, more preferably C₁ or C₂ alkyl, most preferably C₁ alkyl (i.e. methyl); and R₂ is a C₅-C₃₁ hydrocarbyl, preferably straight-chain C₅-C₁₉ alkyl or alkenyl, more preferably straight-chain C₉-C₁₇ alkyl or alkenyl, most preferably straight-chain C₁₁-C₁₇ alkyl or alkenyl, or mixture thereof; and

Z is a polyhydroxyhydrocarbyl having a linear hydrocarbyl chain with at least 3 hydroxyls directly connected to the chain, or an alkoxylated derivative (preferably ethoxylated or propoxylated) thereof.

Z preferably is be derived from a reducing sugar in a reductive amination reaction; more preferably Z is a glycityl.

The non-ionic surfactant may be a condensate of an alkyl phenol. The polyethylene, polypropylene, and polybutylene oxide condensates of alkyl phenols are suitable for use herein. In general, the polyethylene oxide condensates are preferred. These compounds include the condensation products of alkyl phenols having an alkyl group containing from about 6 to about 18 carbon atoms in either a straight chain or branched chain configuration with the alkylene oxide.

The non-ionic surfactant may be an alkoxylated alcohol surfactant. The alkyl alkoxylate condensation products of aliphatic alcohols with from about 1 to about 25 moles of alkylene oxide are suitable for use herein. The alkyl chain of the aliphatic alcohol can either be straight or branched, primary or secondary, and generally contains from 6 to 22 carbon atoms. Particularly preferred are the condensation products of alcohols having an alkyl group containing from 8 to 20 carbon atoms with from about 2 to about 20 moles of alkylene oxide per mole of alcohol. Especially preferred are the condensation products of alcohols having an alkyl group containing from 8 to 11 carbon atoms with from about 4 to about 6 moles of alkylene oxide (preferably ethylene oxide) per mole of alcohol. Examples of these especially preferred surfactants include Berol 840 available from AKZO (this has a carbon chain with 8 carbon atoms and 4 ethylene oxide units), Berol 260 from AKZO (this has a carbon chain with 9 to 11 carbon atoms and 5.5 ethylene oxide units) and Ethylan 1005 (C₁₀ alcohol ethoxylate with 5 ethylene oxide units) used singularly or in combination. These surfactant compositions have been found to have an excellent release rate and rinse performance and are low foaming.

The non-ionic surfactant may be ethoxylated/propoxylated fatty alcohol surfactant. The ethoxylated C₆-C₁₈ fatty alcohols and C₆-C₁₈ mixed ethoxylated/propoxylated fatty alcohols are highly preferred surfactants for use herein, particularly where water soluble. Preferably the ethoxylated fatty alcohols are the C₁₀-C₁₈ ethoxylated fatty alcohols with a degree of ethoxylation of from 3 to 50, most preferably these are the C₁₂-C₁₈ ethoxylated fatty alcohols with a degree of ethoxylation from 3 to 40. Preferably the mixed ethoxylated/propoxylated fatty alcohols have an alkyl chain length of from 10 to 18 carbon atoms, a degree of ethoxylation of from 3 to 30 and a degree of propoxylation of from 1 to 10.

The non-ionic surfactant may be an EO/PO condensates with propylene glycol. The condensation products of ethylene oxide with a hydrophobic base formed by the condensation of propylene oxide with propylene glycol are suitable for use herein. The hydrophobic portion of these compounds preferably has a molecular weight of from about 1500 to about 1800 and exhibits water insolubility. Examples of compounds of this type include certain of the commercially-available Pluronic™ surfactants, marketed by BASF.

The non-ionic surfactant may be an EO condensation products with propylene oxide/ethylene diamine adducts. The condensation products of ethylene oxide with the product resulting from the reaction of propylene oxide and ethylenediamine are suitable for use herein. The hydrophobic moiety of these products consists of the reaction product of ethylenediamine and excess propylene oxide, and generally has a molecular weight of from about 2500 to about 3000. Examples of this type of non-ionic surfactant include certain of the commercially available Tetronic™ compounds, marketed by BASF.

The non-ionic surfactant may be an alkyl-polysaccharide surfactant. Suitable alkylpolysaccharides for use herein have a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g. glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g. between the one position of the additional saccharide units and the 2-, 3-, 4-, and/or 6-positions on the preceding saccharide units.

The surfactant may be a fatty acid amide surfactant. Fatty acid amide surfactants suitable for use herein are those having the formula: wherein R is an alkyl group containing from 7 to 21, preferably from 9 to 17 carbon atoms and each R is selected from the group consisting of hydrogen, C₁-C₄ alkyl, C₁-C₄ hydroxyalkyl, and —(C₂H₄O)ₓH, where x is in the range of from 1 to 3.

Most preferred surfactants are alkoxylated C₉-C₁₈ alcohols. Such surfactants are commercially available under the Tradenames Plurafac LF 305 (available from BASF) and Synperonic RA 30 (available from Uniquema).

The emanator may be used in the dispense of an admixture comprising a surfactant and a further component. Namely, the emanator may be used to dispense a “2-in-1” additive. A preferred example of a multi-component admixture is one containing a surfactant and a fragrance, especially a fragrance that is intended to be released between wash cycles to address any malodour produced by the moist atmosphere of the dishwasher. The use of the emanator allows dosing of both components at the same time during the whole wash cycle. Additionally if the dishwasher is not in use fragrance may still be continuously released, continuously deodorising the dishwasher. Most preferably the surfactant is combined with a fragrance in the ratio of 99:1 to 1:99. Most preferably the membrane is chemically stable in the presence of common fragrances.

The liquid detersive active may comprise an additional detersive agent such as a builder, an acid, an enzyme, a corrosion inhibitor or an admixture thereof.

It will be appreciated that the thickness of the membrane in the emanator will have an influence on the rate of release of the emanator contents.

Generally in the emanator it is preferred that the membrane has a thickness of less than 500 μm, more preferably less than 250 μm, more preferably less than 120 μm. Most preferably the membrane has a thickness of between 15 and 100 μm.

Most preferably the membrane is continuous, that is to say the membrane comprises only a limited number of permanent pores/apertures (preferably equally distributed over the whole active area). Without wishing to be bound by theory it is suggested that the liquid detersive active is transported across the membrane by an active transport mechanism (“active diffusion”).

The membrane may be prepared by any suitable method. Preferred examples of membrane manufacture include casting and blow-moulding.

The membrane may be stabilised with a UV stabiliser or an antioxidant.

Preferred examples of antioxidants comprise compounds which include a sterically hindered phenol, phosphite, phosphonite ester or sulphur group. Preferred examples of UV stabilisers include sterically hindered amines, benzophenone, benzotriazole, benzylidene, malonate, oxanilide, benzooxazinone or triazine. Combinations of sterically hindered amines and phenols are particularly suitable.

The membrane may comprise filling and/or reinforcement materials.

The filling and reinforcement materials may be added at up to 80 wt % of the membrane. As filling and reinforcement materials generally inorganic materials are used. Preferred reinforcement materials are fibrous materials such as glass and carbon fibres. Also mineral fillers such as talcum powder, mica, chalk, kaolin, wool fibres, gypsum, quartz, dolomite, silicates, soot, cellulose and titanium dioxide may be used. The filling/reinforcement material may be surface-treated. Where fibres are used the fibre diameter is generally between 8 and 14 μm.

The emanator may comprise a reservoir body having a substantially planar base with the reservoir projecting from a surface thereof. Most preferably the membrane forms the base of the emanator blister. Preferably the remainder of the reservoir is enclosed in a non-permeable skin. The skin is generally transparent to allow a user to view the contents of the reservoir to determine when a replacement is required. In this form the emanator is particularly suitable for mounting in a cage retaining structure.

Alternatively the emanator may comprise a pouch formed entirely of the membrane.

It will be appreciated that the term blister encompasses both of the structural embodiments contemplated above.

For both the reservoir body and/or the pouch the membrane of the emanator blister preferably has a water soluble polymer layer on the outer surface of the membrane to prevent loss of blister contents during storage.

The invention will now be described with reference to the following non-limiting Examples. Further examples within the scope of the invention will be apparent to the person skilled in the art.

### EXAMPLE

### Preparation of Emanator Blister

A flat square bag comprising two sheets of a 30 μm PET/PBT membrane was prepared by three-sided impulse sealing at the bag periphery. The bag was filled with 25 g of a surfactant composition (a non-ionic alcohol ethoxylate surfactant Lutensol XP40 (BASF)) to be emanated in the dishwasher and sealed.

The dimensions of the bag was 7 cm×7 cm (inside the seals) this results in a surface area of 98 cm².

The bag was then placed into a cage with each 8 apertures (70×3 mm) on front and back to expose an appropriate surface area to the water flow.

### Method of Evaluation of Blister Emanation:

The cage with the bag was then placed in a dishwasher (GENERAL ELECTRICS® GSD 4800) on the upper rack in the plate area and retained with a clip.

The dishwasher was then operated (complete with a commercially available detergent, such as Electrasol “Dual Action” tab) for multiple cycles at the “Normal Wash/Heated Dry” program, including a pre-wash cycle and a main wash cycle. After each complete cycle the bag was removed from the machine and weighed after 24 hours drying to determine the weight loss and hence the amount of bag content that had been emanated in the cycle.

| | | Surfactant | Surfactant Weight |
|---|---|---|---|
| Cycle | Total Weight(g) | Weight (g) | relative to start (%) |
| 0 | 49.570 | 25.28 | 100.0 |
| 1 | 49.348 | 25.06 | 99.1 |
| 2 | 48.895 | 24.61 | 97.3 |
| 3 | 48.343 | 24.05 | 95.1 |
| 4 | 47.894 | 23.61 | 93.4 |
| 5 | 47.054 | 22.77 | 90.0 |
| 6 | 46.746 | 22.46 | 88.8 |
| 7 | 46.272 | 21.98 | 87.0 |
| 8 | 45.440 | 21.15 | 83.7 |
| 9 | 45.357 | 21.07 | 83.3 |
| 10 | 44.883 | 20.59 | 81.5 |
| 11 | 44.296 | 20.01 | 79.1 |
| 12 | 43.739 | 19.45 | 76.9 |
| 13 | 43.064 | 18.78 | 74.3 |
| 14 | 42.891 | 18.60 | 73.6 |
| 15 | 42.269 | 17.98 | 71.1 |
| 16 | 41.972 | 17.68 | 69.9 |
| 17 | 41.349 | 17.06 | 67.5 |
| 18 | 40.578 | 16.29 | 64.4 |
| 19 | 40.151 | 15.86 | 62.7 |
| 20 | 39.788 | 15.50 | 61.3 |
| 21 | 39.411 | 15.12 | 59.8 |
| 22 | 39.026 | 14.74 | 58.3 |
| 23 | 38.398 | 14.11 | 55.8 |
| 24 | 38.156 | 13.87 | 54.9 |
| 25 | 37.703 | 13.41 | 53.1 |
| 26 | 37.444 | 13.16 | 52.0 |
| 27 | 36.890 | 12.60 | 49.8 |
| 28 | 36.484 | 12.20 | 48.2 |
| 29 | 36.101 | 11.81 | 46.7 |
| 30 | 35.772 | 11.48 | 45.4 |
| 31 | 35.402 | 11.11 | 44.0 |
| 32 | 35.030 | 10.74 | 42.5 |
| 33 | 34.502 | 10.21 | 40.4 |
| 34 | 34.271 | 9.98 | 39.5 |
| 35 | 33.929 | 9.64 | 38.1 |
| 36 | 33.574 | 9.29 | 36.7 |
| 37 | 33.083 | 8.79 | 34.8 |
| 38 | 32.778 | 8.49 | 33.6 |
| 39 | 32.453 | 8.16 | 32.3 |
| 40 | 32.151 | 7.86 | 31.1 |
| | 31.804 | 7.52 | 29.7 |

The emanator bag shows an almost linear release rate of surfactant with increasing number of washes. The average rate of release was 0.44 g per wash.

The almost linear release of surfactant is a highly unexpected advantage of an emanator in accordance with the present invention.

The result achieved is further unexpected when compared with previous fragrance emanator blisters which normally release their fragrance content in an exponential release.

1. An emanator blister, having a membrane comprising PET/PBT, the blister containing a liquid detersive active.

2. An emanator blister according to claim 1, wherein the membrane comprises a protective layer to keep the liquid detersive active from migrating through the membrane when the product is in storage or transport.

3. An emanator blister according to claim 2, wherein the protective layer and the membrane are in the form of a laminate, glued together.

4. An emanator blister according to claim 2, wherein the protective layer is PVOH.

5. An emanator blister according to claim 1, wherein the liquid detersive active comprises a surfactant.

6. An emanator blister according to claim 1, wherein the liquid detersive active comprises a detersive agent.

7. An emanator blister according to claim 6, wherein the detersive agent is a builder, an acid, an enzyme, a corrosion inhibitor or an admixture thereof.

8. An emanator blister according to claim 1, wherein the membrane has a thickness of less than 500 μm.

9. An emanator blister according to claim 1, wherein the emanator comprises a reservoir body having a substantially planar base with the reservoir projecting from a surface thereof.

10. An emanator blister according to claim 9, wherein the membrane forms the base of the emanator blister.

11. An emanator blister according to claim 9, wherein the reservoir body is transparent

12. An emanator blister according to claim 1, adapted for use in an automatic dishwasher.

13. An emanator blister according to claim 3, wherein the protective layer is PVOH.

14. An emanator blister according to claim 2 wherein the liquid detersive active comprises a surfactant

15. An emanator blister according to claim 3 wherein the liquid detersive active comprises a surfactant

16. An emanator blister according to claim 4 wherein the liquid detersive active comprises a surfactant.

17. An emanator blister according to claim 1 wherein the membrane has a thickness of less than 250 μm.

18. An emanator blister according to claim 1 wherein the membrane has a thickness of less than 120 μm.

19. A method of delivering a liquid detersive active to the interior of a dishwasher, the method comprising the steps of:
providing an emanator blister to the interior of a dishwashwer; and,
operating the dishwasher.
